(19) United States
(12) Patent Application Publication
(10) Pub. No.: US 2025/0054272 A1
(43) Pub. Date: Feb. 13, 2025

(54) METHOD, APPARATUS AND COMPUTER PROGRAM PRODUCT FOR TRAINING REFERENCE PICTURE SCREENING MODEL

(71) Applicant: Beijing Baidu Netcom Science Technology Co., Ltd., Beijing (CN)

(72) Inventor: Xu ZHANG, Beijing (CN)

(21) Appl. No.: 18/749,546

(22) Filed: Jun. 20, 2024

(30) Foreign Application Priority Data
Aug. 4, 2023 (CN) 202310981749.8

(51) Int. Cl. G06V 10/44; G06V 20/70; H04N 19/176

(52) U.S. Cl. CPC G06V 10/44; G06V 20/70; H04N 19/176

(57) ABSTRACT

The present disclosure provides a method and apparatus for training a reference frame screening model, a method and apparatus for screening a reference frame, an electronic device, a storage medium, and a computer program product, relates to the field of artificial intelligence. An implementation scheme is: acquiring a training sample set, where training samples in the training sample set include a sequence of video frames and labels corresponding to video frames in the sequence of video frames, and the labels are used to represent whether the video frames corresponding to the labels are reference frames of other video frames in the sequence of video frames; and training, using a machine learning method, using the sequence of video frames as input, using the labels corresponding to the input sequence of video frames as desired output, to obtain a reference frame screening model.

### CROSS-REFERENCE TO RELATED APPLICATIONS

This application claims priority to Chinese Patent Application No. 202310981749.8, filed with the China National Intellectual Property Administration (CNIPA) on Aug. 4, 2023, the contents of which are incorporated herein by reference in their entirety.

### TECHNICAL FIELD

The present disclosure relates to the field of artificial intelligence, in particular to the fields of cloud computing, video coding and decoding, and media cloud technology, and more particularly, to a method and apparatus for training a reference frame screening model, a method and apparatus for screening a reference frame, an electronic device, a storage medium, and a computer program product, which may be applied in intelligent cloud scenarios.

### BACKGROUND

HEVC (High Efficiency Video Coding) uses RPS (Reference Picture Set) technology to manage decoded frames to be used as a reference for subsequent video frames. In HEVC standard, all possible reference frames may be stored in a reference frame chain list (Reference Picture Set). According to the current strategy for reference frame selection, a sufficient number of reference frames are selected by starting from a header of the reference frame chain list and selecting backwards in sequence.

### SUMMARY

The present disclosure provides a method and apparatus for training a reference frame screening model, a method and apparatus for screening a reference frame, an electronic device, a storage medium, and a computer program product.

According to a first aspect, a method for training a reference frame screening model is provided, including: acquiring a training sample set, where training samples in the training sample set include a sequence of video frames and labels corresponding to video frames in the sequence of video frames, and the labels are used to represent whether the video frames corresponding to the labels are reference frames of other video frames in the sequence of video frames; and training, using a machine learning method, using the sequence of video frames as input, using the labels corresponding to the input sequence of video frames as desired output, to obtain a reference frame screening model.

According to a second aspect, a method for screening a reference frame is provided, including: acquiring a target video sequence; screening, for each video frame in the target video sequence, using a pre-trained reference frame screening model, target reference frames corresponding to the video frame from a set of candidate reference frames corresponding to the video frame, to obtain a set of target reference frames, where, the reference frame screening model is obtained from training according to any one of the implementations in the first aspect.

According to a third aspect, an apparatus for training a reference frame screening model is provided, including: a first acquisition unit, configured to acquire a training sample set, wherein training samples in the training sample set comprise a sequence of video frames and labels corresponding to video frames in the sequence of video frames, and the labels are used to represent whether the video frames corresponding to the labels are reference frames of other video frames in the sequence of video frames; and a training unit, configured to train, using a machine learning method, using the sequence of video frames as input, using the labels corresponding to the input sequence of video frames as desired output, to obtain a reference frame screening model.

According to a fourth aspect, an apparatus for screening a reference frame is provided, including: a second acquisition unit, configured to acquire a target video sequence; and a screening unit, configured to screen, for each video frame in the target video sequence, using a pre-trained reference frame screening model, target reference frames corresponding to the video frame from a set of candidate reference frames corresponding to the video frame, to obtain a set of target reference frames, wherein, the reference frame screening model is obtained from training according to any one of the implementations in the third aspect.

According to a fifth aspect, an electronic device is provided, comprising: one or more processors; and a memory, storing one or more programs, wherein the one or more programs, when executed by the one or more processors, cause the one or more processors to implement the method provided according to any one of the implementations in the first aspect or the second aspect.

According to a sixth aspect, a computer-readable medium storing a computer program thereon is provided, where the program, when executed by a processor, causes the processor to implement the method provided according to any one of the implementations in the first aspect or the second aspect.

According to a seventh aspect, a computer program product is provided, comprising a computer program, where the computer program, when executed by a processor, implements the method provided according to any one of the implementations in the first aspect or the second aspect.

It should be understood that the content described in this section is not intended to identify critical or important features of embodiments of the present disclosure, and is not used to limit the scope of the present disclosure. Other features of the present disclosure will become readily comprehensible through the following description.

### BRIEF DESCRIPTION OF THE DRAWINGS

The accompanying drawings are used for a better understanding of the present scheme, and do not constitute a limitation of the present disclosure, in which:

FIG. 1 is an example system architecture diagram in which an embodiment of the present disclosure may be applied;

FIG. 2 is a flowchart of an embodiment of a method for training a reference frame screening model according to the present disclosure;

FIG. 3 is a schematic diagram of an application scenario of the method for training a reference frame screening model according to the present disclosure;

FIG. 4 is a flowchart of another embodiment of the method for training a reference frame screening model according to the present disclosure;

FIG. 5 is a flowchart of an embodiment of a method for screening a reference frame according to the present disclosure;

FIG. 6 is a flowchart of another embodiment of the method for screening a reference frame according to the present disclosure;

FIG. 7 is a structural diagram of an embodiment of an apparatus for training a reference frame screening model according to the present disclosure;

FIG. 8 is a structural diagram of an embodiment of an apparatus for screening a reference frame according to the present disclosure; and

FIG. 9 is a schematic structural diagram of a computer system suitable for implementing embodiments of the present disclosure.

### DETAILED DESCRIPTION OF EMBODIMENTS

Exemplary embodiments of present disclosure are described below with reference to the accompanying drawings, which include various details of the embodiments of the present disclosure to facilitate understanding, and should be considered as merely exemplary. Therefore, those of ordinary skill in the art should realize that various changes and modifications can be made to the embodiments described herein without departing from the scope and spirit of the present disclosure. Likewise, for clarity and conciseness, descriptions of well-known functions and structures are omitted in the following description.

In the technical scheme of the present disclosure, the collection, storage, use, processing, transmission, provision and disclosure of the user's personal information are processed in accordance with relevant laws and regulations, and do not violate public order and good customs.

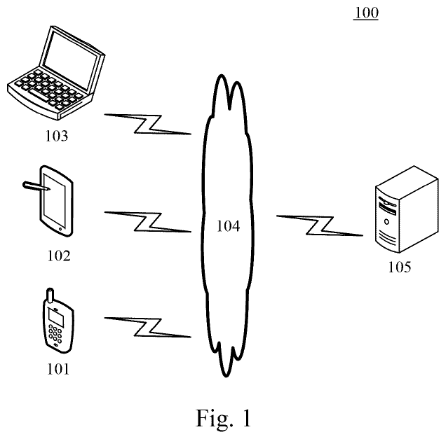

FIG. 1 illustrates an example architecture 100 in which a method and apparatus for training a reference frame screening model, and a method and apparatus for screening a reference frame according to the present disclosure may be applied.

As shown in FIG. 1, the system architecture 100 may include terminal devices 101, 102 and 103, a network 104, and a server 105. Communication connections between the terminal devices 101, 102, 103 form a topological network, and the network 104 serves as a medium providing a communication link between the terminal devices 101, 102 and 103 and the server 105. The network 104 may include various types of connections, for example, wired or wireless communication links, or optical fiber cables.

The terminal devices 101, 102, 103 may be hardware devices or software that support network connection and thus performing data interaction and data processing. When the terminal devices 101, 102, 103 are hardware, they may be various electronic devices that support functions such as network connection, information acquisition, interaction, display, or processing, including but not limited to smartphones, tablets, e-book readers, laptops, desktop computers, or the like. When the terminal devices 101, 102, 103 are software, they may be installed in the electronic devices listed above. The terminal devices 101, 102, 103 may be implemented as, for example, a plurality of software or software modules for providing distributed services, or as a single software or software module, which will not be limited herein.

The server 105 may be a server providing various services, for example, a backend processing server that receives a training sample set provided by the terminal devices 101, 102, 103 and trains to obtain a reference frame screening model using a machine learning method; or, for example, a backend processing server that screens, for a set of candidate reference frames corresponding to each video frame in a target video sequence provided by the terminal devices 101, 102, 103, using a pre-trained reference frame screening model, candidate reference frames in the set of candidate reference frames. As an example, the server 105 may be a cloud server.

It should be noted that the server may be hardware or software. When the server is hardware, it may be implemented as a distributed server cluster consist of multiple servers, or as a single server. When the server is software, it may be implemented as a plurality of software or software modules (e.g., software or software modules used to provide distributed services), or as a single software or software module, which will not be limited herein.

It should also be noted that the method for training a reference frame screening model and the method for screening a reference frame provided in embodiments of the present disclosure may be performed by the server, or may be performed by the terminal devices, or may be performed by the server and the terminal devices in cooperation with each other. Accordingly, parts (e.g., units) included in the apparatus for training a reference frame screening model and the apparatus for screening a reference frame may be provided all in the server, all in the terminal devices, or separately in the server and the terminal devices.

It should be appreciated that the numbers of the terminal devices, the networks and the servers in FIG. 1 are merely illustrative. Any number of terminal devices, networks and servers may be provided depending on implementation needs. The system architecture may include only an electronic device (e.g., the server or the terminal devices) on which the method for training a reference frame screening model, the method for screening a reference frame run, when the electronic device on which the method for training a reference frame screening model, the method for screening a reference frame run does not need to transfer data with other electronic devices.

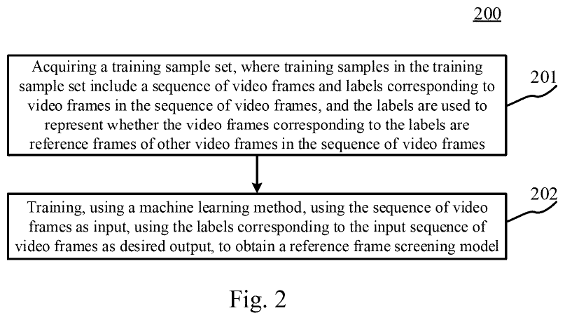

Referring to FIG. 2, FIG. 2 is a flowchart of a method for training a reference frame screening model provided by an embodiment of the present disclosure. In flow 200, the following steps are included:

Step 201, acquiring a training sample set.

In the present embodiment, an executing body of the method for training a reference frame screening model (for example, the terminal devices or the server in FIG. 1) may acquire the training sample set either remotely or locally, via a wired network connection or a wireless network connection.

Here, training samples in the training sample set include a sequence of video frames and labels corresponding to video frames in the sequence of video frames, and the labels are used to represent whether the video frames corresponding to the labels are reference frames of other video frames in the sequence of video frames.

As an example, the sequence of video frames includes 50 consecutive video frames f1-f50, in which video frame f20 has reference frames f21, f24, and f25, then for video frame f20, its corresponding label represents that video frames f21, f24, and f25 are reference frames of video frame f20.

In this implementation, for each video frame in the sequence of video frames that needs to refer to other frames for coding and decoding operations, its corresponding label may be set to represent the reference frames corresponding to the video frame.

In order to improve richness of the training samples in the training sample set, as well as a generalization ability of a trained reference frame screening model, the executing body may select a plurality of video sequences having high variability based on time domain complexity and space domain complexity of the sequence of video frames in order to generate the training sample set.

As an example, for each complexity in the time domain complexity and the space domain complexity, the executing body may set a corresponding complexity level, and different complexity levels correspond to different complexity value ranges; furthermore, for each complexity level, a video sequence belonging to the complexity level is selected to generate a training sample; and finally, a plurality of training samples of different time domain complexity and different space domain complexity are combined to obtain the training sample set.

Here, the time domain complexity may be calculated from a frame rate or duration of the video sequence, and the space domain complexity may be calculated from the number of pixels of each video frame in the video sequence.

In some alternative implementations of the present embodiment, for each video frame in the sequence of video frames, the label corresponding to the video frame is determined by:

First, determining, in response to completing a coding operation of the video frame, the number of times each reference frame in a set of reference frames corresponding to the video frame, is referenced in the coding operation of the video frame.

A video sequence generally includes I-frames, P-frames and B-frames. Here, I-frames are intra-frame coded frames, and the coding and decoding process does not need to refer to other video frames; P-frames are forward predictive coded frames, and the coding and decoding process needs to refer to forward video frames; and B-frames are bi-directional predictive coded frames, and the coding and decoding process generally needs to refer to forward and/or backward video frames. In inter-frame predictive coding, due to the existence of a certain correlation between objects in adjacent video frames, the video frames may be divided into a number of coded blocks, trying to search out a position of each coded block in the adjacent video frames and deriving a relative offset of spatial positions between the two. The relative offset obtained is commonly referred to as a motion vector, and the process of obtaining the motion vector is known as motion estimation.

The motion vector and a prediction error obtained after motion matching are jointly sent to a decoding terminal, where the corresponding coded block is found from images of adjacent reference frames that have been decoded according to the position indicated by the motion vector, and the position of the coded block in the current coded frame is obtained by summing with the prediction error. Inter-frame redundancy may be removed by motion estimation, so that the number of bits in video transmission is significantly reduced.

As can be seen, for coded blocks in B-frames and P-frames, other video frames are generally referenced to determine the motion vectors; generally speaking, a video frame may include multiple coded blocks, each of which references other video frames to determine the motion vector, and the video frames referenced by different coded blocks may be the same. The process of referencing other video frames by the coded block may be viewed as the other video frames being referenced once by the video frame.

As an example, video frame f1 includes 16 coded blocks, where the coded blocks 1, 4, 5 all reference video frame f2, then the number of times the reference frame f2 is referenced in the coding operation of video frame f1 is 3.

Here, the set of reference frames corresponding to each video frame may be a set of reference frames of video frames determined based on HEVC technology.

Secondly, determining, based on the number of times corresponding to each reference frame is referenced in the set of reference frames, the label corresponding to the video frame.

As an example, the executing body may set a number of times threshold, and in response to determining that the number of times corresponding to the reference frame is referenced in the coding process of the video frame is greater than the number of times threshold, set the label representing the reference frame as a reference frame of the video frame.

Here, the number of times threshold may be set according to the actual situation and is not limited herein.

In this implementation, the method for determining the label corresponding to the video frame is provided, the number of times each reference frame in the set of reference frames is referenced in the coding operation of the video frame is used to determine whether the reference frame in the set of reference frames is a reference frame of the video frame, improving an accuracy of the label.

In some alternative implementations of the present embodiment, the executing body may perform the above first step as follows: determining, in response to completing the coding operation of the video frame based on a coded block of a preset size, the number of times each reference frame in the set of reference frames corresponding to the video frame, is referenced in the coding operation of the video frame.

Here, the preset size may be set according to the actual situation. As an example, the preset size may be 4×4, 8×8, and 16×16.

In this implementation, the executing body may perform the above second step as follows:

First, determining, for each reference frame in the set of reference frames, based on the number of times being referenced corresponding to the reference frame and the number of the coded blocks in the video frame, a ratio of being referenced of the reference frame in the coding operation of the video frame.

In particular, for each reference frame in the set of reference frames, the number of times being referenced corresponding to the reference frame is divided by the number of the coded blocks in the video frame to obtain the ratio of being referenced of the reference frame in the coding operation of the video frame.

Using video frame f1 having a size of 1920×1080 and the preset size of 8×8 as an example, the number of the coded blocks in the video frame is 32400. The number of times the reference frame f2 is referenced is 10000, then the ratio of being referenced of the reference frame f2 in the coding operation of video frame f1 is about 31%.

Secondly, determining, based on the ratio of being referenced corresponding to each reference frame in the set of reference frames, the label corresponding to the video frame.

In this implementation, the executing body may preset a ratio threshold, and in response to determining that the ratio of being referenced corresponding to the reference frame in the coding process of the video frame is greater than the ratio threshold, set the label representing the reference frame as a reference frame of the video frame.

Here, the ratio threshold may be set according to the actual situation and is not limited herein.

In this implementation, the accuracy of the label is further improved by determining the label corresponding to the video frame using the ratio of being referenced.

Step 202, training, using a machine learning method, using the sequence of video frames as input, using the labels corresponding to the input sequence of video frames as desired output, to obtain a reference frame screening model.

In the present embodiment, the executing body may train to obtain the reference frame screening model, using the machine learning method, using the sequence of video frames as the input, and using the labels corresponding to the input sequence of video frames as the desired output.

As an example, in response to not reaching a preset end condition, cyclically performing training operations as follows:

selecting untrained target training samples from the training sample set, inputting a sequence of video frames in the target training samples into an initial reference frame screening model to obtain an actual output; calculating a loss between the actual output and labels in the target training samples; determining an updating gradient of the model based on the loss, then updating a parameter of the initial reference frame screening model using a stochastic gradient descent method, to obtain the initial reference frame screening model corresponding to a next training operation.

Here, the preset end condition may be, for example, that training time exceeds a preset time threshold, the number of training sessions exceeds a preset number of sessions threshold, and the training loss tends to converge.

The reference frame screening model may use neural network models having classification functions, such as XGBoost (Extreme Gradient Boosting) model, fully connected neural network model, recurrent neural network model, or residual network model.

In some alternative implementations of the present embodiment, the executing body may perform the above step 202 as follows:

training, using the machine learning method, for each video frame in the sequence of video frames, using the video frame as the input, and using a label corresponding to the video frame as the desired output, to obtain the reference frame screening model.

As an example, in response to not reaching the preset end condition, cyclically performing training operations as follows:

selecting untrained target training samples from the training sample set, inputting each video frame in a sequence of video frames in the target training samples into an initial reference frame screening model to obtain an actual output corresponding to each video frame; calculating a loss between the actual output and the label corresponding to each video frame in the target training samples; determining an updating gradient of the model based on the loss, then updating a parameter of the initial reference frame screening model using a stochastic gradient descent method, to obtain the initial reference frame screening model corresponding to a next training operation.

In this implementation, machine learning of the reference frame screening model in terms of video frames helps to further improve an accuracy of the obtained reference frame screening model.

In some alternative implementations of the present embodiment, the executing body may perform the above training steps as follows:

First, extracting a feature dataset of each video frame in the sequence of video frames, based on a preset feature set.

Here, the preset feature set includes a plurality of feature types indicating the video frames in the sequence of video frames for feature collection. As an example, the preset feature set includes the number of inter blocks, the number of intra blocks of video frames and the corresponding reference frames in a lookahead flow, an intra-frame cost, a QP (Quantization Parameter), a frame type of the reference frame, a frame type of the current video frame, an image luminance mean, a luminance variance, or the like.

Secondly, training, using the machine learning method, for each video frame in the sequence of video frames, using the feature dataset corresponding to the video frame as the input, and using the label corresponding to the video frame as the desired output, to obtain the reference frame screening model.

In this implementation, through the preset feature set, the executing body may be instructed to extract the feature dataset of the video frame, which improves the richness of data features and helps to improve the accuracy of the trained reference frame screening model; moreover, the feature type may be specified to guide the training process of the model, which helps to improve the speed of model training.

In some alternative implementations of the present embodiment, the executing body may also perform the following operation: determining importance of each feature data in the feature dataset in a training process.

In this implementation, the executing body may perform the above second step as follows:

first, screening target feature data from the feature dataset based on the importance of the feature data determined in the training process; then, training, using the machine learning method, for each video frame in the sequence of video frames, using a target feature dataset corresponding to the video frame as the input, and using the label corresponding to the video frame as the desired output, to obtain the reference frame screening model.

As an example, in the training process, corresponding, learnable importance parameters may be set for features of various feature types, and the importance parameters may be updated with the training process of the model.

In the training process, the importance of the feature data may be determined based on values of the importance parameters, so that the target feature data may be screened therefrom to perform the training operations of the model.

For example, the screened target feature data is feature data corresponding to the feature types, such as the number of inter blocks, the number of intra blocks, or the QP.

In this implementation, screening the more important target feature data to perform training operations in the training process, reduces a data volume in the training process, while ensuring accuracy of the training, which helps to further improve the speed of model training.

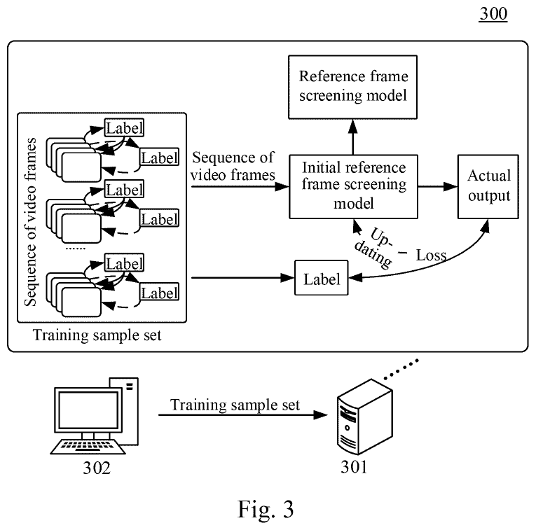

With further reference to FIG. 3, FIG. 3 is a schematic diagram 300 of an application scenario of the method for training a reference frame screening model according to the present embodiment. In the application scenario of FIG. 3, an initial reference frame screening model is deployed in a server 301, and in order to train the initial reference frame screening model, a training sample set is acquired from a terminal device 302. Training samples in the training sample set include a sequence of video frames and labels corresponding to the video frames in the sequence of video frames, and the labels are used to represent whether the video frames corresponding to the labels are reference frames of other video frames in the sequence of video frames. In the training process, a machine learning method is used to train to obtain a reference frame screening model, using the sequence of video frames as input and using the labels corresponding to the input sequence of video frames as desired output.

In the present embodiment, a method for training a reference frame screening model is provided, using the machine learning method, using the sequence of video frames in the training samples as the input, and using the labels representing whether the video frames are reference frames of other video frames in the sequence of video frames in the training samples as the desired output, training to obtain the reference frame screening model, which improves the accuracy of the reference frame screening model.

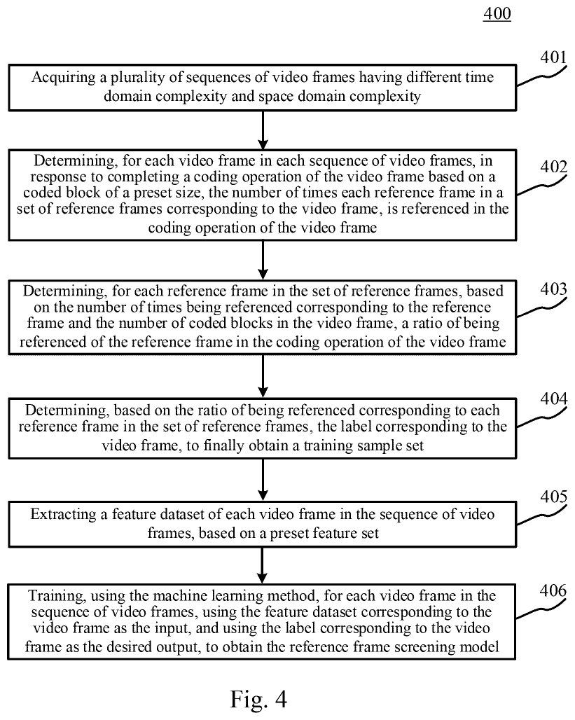

With further reference to FIG. 4, a schematic flow 400 of another embodiment of the method for training a reference frame screening model according to the present disclosure is illustrated. In the flow 400, the following steps are included:

Step 401, acquiring a plurality of sequences of video frames having different time domain complexity and space domain complexity.

Step 402, determining, for each video frame in each sequence of video frames, in response to completing a coding operation of the video frame based on a coded block of a preset size, the number of times each reference frame in a set of reference frames corresponding to the video frame, is referenced in the coding operation of the video frame.

Step 403, determining, for each reference frame in the set of reference frames, based on the number of times being referenced corresponding to the reference frame and the number of coded blocks in the video frame, a ratio of being referenced of the reference frame in the coding operation of the video frame.

Step 404, determining, based on the ratio of being referenced corresponding to each reference frame in the set of reference frames, the label corresponding to the video frame, to finally obtain a training sample set.

Step 405, extracting a feature dataset of each video frame in the sequence of video frames, based on a preset feature set.

Here, the preset feature set includes a plurality of feature types indicating the video frames in the sequence of video frames for feature collection.

Step 406, training, using the machine learning method, for each video frame in the sequence of video frames, using the feature dataset corresponding to the video frame as the input, and using the label corresponding to the video frame as the desired output, to obtain the reference frame screening model.

As can be seen from the present embodiment, the flow 400 of the method for training a reference frame screening model in the present embodiment specifies the process of determining the labels in the training samples, and the training process of the reference frame screening model, which further improves the accuracy of the obtained reference frame screening model, as compared to the embodiment corresponding to FIG. 2.

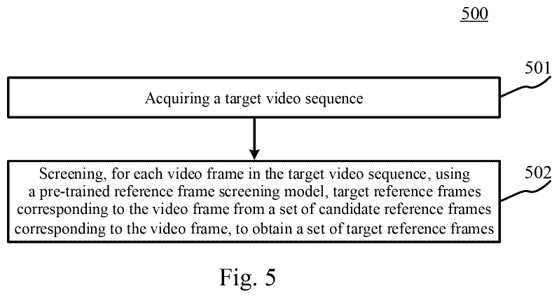

With further reference to FIG. 5, FIG. 5 is a flowchart of a method for screening a reference frame provided by an embodiment of the present disclosure. In flow 500, the following steps are included:

Step 501, acquiring a target video sequence.

In the present embodiment, an executing body of the method for screening a reference frame (for example, the terminal devices or the server in FIG. 1) may acquire the target video sequence either remotely or locally, via a wired network connection or a wireless network connection.

The sequence of video frames includes a plurality of consecutive video frames for representing video data.

Step 502, screening, for each video frame in the target video sequence, using a pre-trained reference frame screening model, target reference frames corresponding to the video frame from a set of candidate reference frames corresponding to the video frame, to obtain a set of target reference frames.

In the present embodiment, for each video frame in the target video sequence, the executing body may screen the target reference frames corresponding to the video frame from the set of candidate reference frames corresponding to the video frame, using the pre-trained reference frame screening model, to obtain the set of target reference frames.

Here, the reference frame screening model is obtained from the above embodiments 200, 400.

As an example, for each video frame in the target video sequence, candidate reference frames in the set of candidate reference frames corresponding to the video frame may be classified by using the pre-trained reference frame screening model, and the target reference frames corresponding to the video frame may be determined based on classification results to obtain the set of target reference frames.

Here, the set of candidate reference frames corresponding to the video frame may be a set of reference frames corresponding to the video frame determined based on the HEVC technology.

In some alternative implementations of the present embodiment, the executing body may perform the above step 502 as follows: in response to determining that the number of target reference frames in the set of target reference frames does not exceed a preset number threshold, cyclically performing determination operations as follows:

first, extracting a candidate reference frame from the set of candidate reference frames corresponding to the video frame, and extracting target feature data corresponding to the candidate reference frame; then, inputting the target feature data into the reference frame screening model to determine whether the candidate reference frame is a target reference frame corresponding to the video frame; and finally, adding, in response to determining that the candidate reference frame is the target reference frame, the candidate reference frame to the set of target reference frames.

Here, the preset number threshold may be set according to the actual situation and is not limited herein.

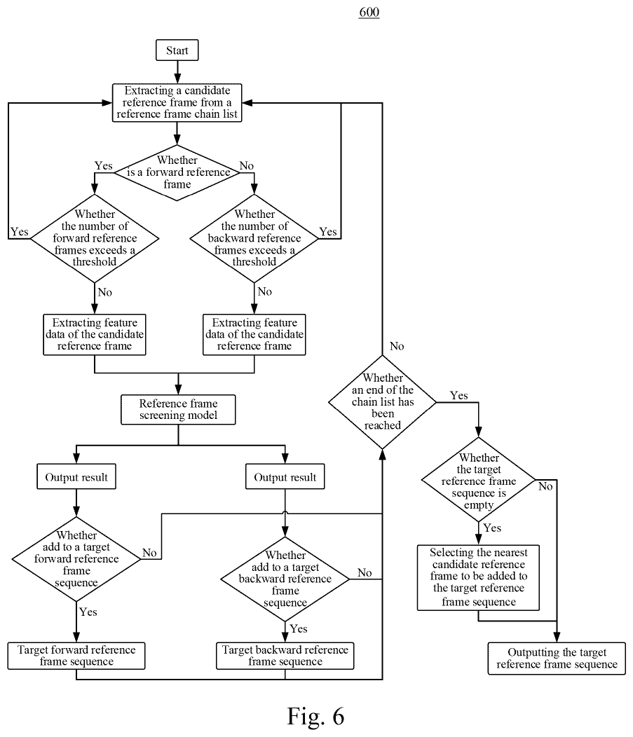

With further reference to FIG. 6, illustrating a schematic flowchart of the method for screening a reference frame. In flow 600, for each video frame in a sequence of target video frames, the target reference frame of the video frame may be screened through the following steps:
1. extracting a candidate reference frame from a reference frame chain list (set of reference frames). Here, the reference frame chain list corresponding to the video frame may be determined based on the HEVC technology.
2. determining whether the selected candidate reference frame is a forward reference frame.
3. in response to determining that the candidate reference frame is a forward reference frame, further judging whether the number of forward reference frames corresponding to the current video frame exceeds a preset forward reference frame threshold.
4. in response to determining that the candidate reference frame is a backward reference frame, further judging whether the number of backward reference frames corresponding to the current video frame exceeds a preset backward reference frame threshold.
5. in response to not exceeding the corresponding preset threshold (in particular, the preset forward reference frame threshold, or the preset backward reference frame threshold), extracting feature data of the forward reference frame or the backward reference frame.
6. inputting the feature data into the reference frame screening model to determine whether to add the selected reference frame to the set of target reference frames (in particular, a set of target forward reference frames, or a set of target backward reference frames).
7. determining whether an end of the reference frame chain list has been reached.
8. in response to not reaching the end of the reference frame chain list, or, alternatively, the number of forward reference frames exceeds the preset forward reference frame threshold, or, alternatively, the number of backward reference frames exceeds the preset backward reference frame threshold, continue performing step 1.
9. in response to reaching the end of the reference frame chain list, determining whether the number of target reference frames in the set of target reference frames is 0; if it is 0, selecting a reference frame that is close to the current video frame from the reference frame chain list to be added to the set of target reference frames; if it is not 0, directly outputting the set of target reference frames.

After determining the set of target reference frames corresponding to the video frame, coding and decoding operations may be performed on the video frame based on the determined set of target reference frames.

In the present embodiment, a method for screening a reference frame is provided, by screening a set of reference frames corresponding to each video frame in a video sequence using the reference frame screening model, a selection range of reference frames is increased, fitness between the screened reference frames and the video frame is improved, and an accuracy of motion estimation results is improved.

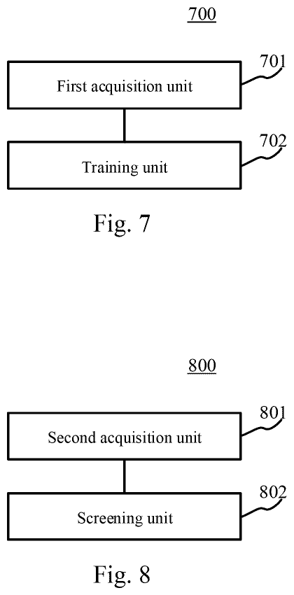

With further reference to FIG. 7, as an implementation of the method shown in the above figures, the present disclosure provides an embodiment of an apparatus for training a reference frame screening model, and the apparatus embodiment corresponds to the method embodiment shown in FIG. 2, the apparatus may be applied to various electronic devices.

As shown in FIG. 7, an apparatus 700 for training a reference frame screening model includes: a first acquisition unit 701, configured to acquire a training sample set, where training samples in the training sample set include a sequence of video frames and labels corresponding to video frames in the sequence of video frames, and the labels are used to represent whether the video frames corresponding to the labels are reference frames of other video frames in the sequence of video frames; and a training unit 702, configured to train, using a machine learning method, using the sequence of video frames as input, using the labels corresponding to the input sequence of video frames as desired output, to obtain a reference frame screening model.

In some alternative implementations of the present embodiment, the training unit 702 is further configured to: train, using the machine learning method, for each video frame in the sequence of video frames, using the video frame as the input, and using a label corresponding to the video frame as the desired output, to obtain the reference frame screening model.

In some alternative implementations of the present embodiment, the training unit 702 is further configured to: extract a feature dataset of each video frame in the sequence of video frames, based on a preset feature set, where the preset feature set includes a plurality of feature types indicating the video frames in the sequence of video frames for feature collection; and train, using the machine learning method, for each video frame in the sequence of video frames, using the feature dataset corresponding to the video frame as the input, and using the label corresponding to the video frame as the desired output, to obtain the reference frame screening model.

In some alternative implementations of the present embodiment, the apparatus further includes: a first determination unit (not shown in the figures), configured to determine importance of each feature data in the feature dataset in a training process; and the training unit 702 is further configured to: screen target feature data from the feature dataset based on the importance of the feature data determined in the training process; and train, using the machine learning method, for each video frame in the sequence of video frames, using a target feature dataset corresponding to the video frame as the input, and using the label corresponding to the video frame as the desired output, to obtain the reference frame screening model.

In some alternative implementations of the present embodiment, the apparatus further includes: a second determination unit (not shown in the figure), configured to: for each video frame in the sequence of video frames, determine the label corresponding to the video frame by: determining, in response to completing a coding operation of the video frame, the number of times each reference frame in a set of reference frames corresponding to the video frame, is referenced in the coding operation of the video frame; and determining, based on the number of times corresponding to each reference frame is referenced in the set of reference frames, the label corresponding to the video frame.

In some alternative implementations of the present embodiment, the second determination unit (not shown in the figure) is further configured to: determine, in response to completing the coding operation of the video frame based on a coded block of a preset size, the number of times each reference frame in the set of reference frames corresponding to the video frame, is referenced in the coding operation of the video frame; determine, for each reference frame in the set of reference frames, based on the number of times being referenced corresponding to the reference frame and the number of the coded blocks in the video frame, a ratio of being referenced of the reference frame in the coding operation of the video frame; and determine, based on the ratio of being referenced corresponding to each reference frame in the set of reference frames, the label corresponding to the video frame.

In the present embodiment, an apparatus for training a reference frame screening model is provided, using the machine learning method, using the sequence of video frames in the training samples as the input, and using the labels representing whether the video frames are reference frames of other video frames in the sequence of video frames in the training samples as the desired output, training to obtain the reference frame screening model, which improves the accuracy of the reference frame screening model.

With further reference to FIG. 8, as an implementation of the method shown in the above figures, the present disclosure provides an embodiment of an apparatus for screening a reference frame, and the apparatus embodiment corresponds to the method embodiment shown in FIG. 5, the apparatus may be applied to various electronic devices.

As shown in FIG. 8, an apparatus 800 for screening a reference frame includes: a second acquisition unit 801, configured to acquire a target video sequence; and a screening unit 802, configured to screen, for each video frame in the target video sequence, using a pre-trained reference frame screening model, target reference frames corresponding to the video frame from a set of candidate reference frames corresponding to the video frame, to obtain a set of target reference frames, where, the reference frame screening model is obtained from training according to any one of the implementations in the above embodiment 700.

In some alternative implementations of the present embodiment, the screening unit 802 is further configured to: in response to determining that the number of target reference frames in the set of target reference frames does not exceed a preset number threshold, cyclically perform determination operations as follows: extracting a candidate reference frame from the set of candidate reference frames corresponding to the video frame, and extracting target feature data corresponding to the candidate reference frame; inputting the target feature data into the reference frame screening model to determine whether the candidate reference frame is a target reference frame corresponding to the video frame; and adding, in response to determining that the candidate reference frame is the target reference frame, the candidate reference frame to the set of target reference frames.

In the present embodiment, an apparatus for screening a reference frame is provided, by screening a set of reference frames corresponding to each video frame in a video sequence using the reference frame screening model, a selection range of reference frames is increased, fitness between the screened reference frames and the video frame is improved, and an accuracy of motion estimation results is improved.

According to an embodiment of the present disclosure, the present disclosure also provides an electronic device, including: at least one processor; and a memory, communicatively connected to the at least one processor; where, the memory stores instructions executable by the at least one processor, the instructions being executed by the at least one processor to enable the at least one processor to perform the method for training a reference frame screening model, the method for screening a reference frame as described in any one of the above embodiments.

According to an embodiment of the present disclosure, the present disclosure also provides a readable storage medium storing a computer instruction, where, the computer instruction is used to cause the computer to perform the method for training a reference frame screening model, the method for screening a reference frame as described in any one of the above embodiments.

According to an embodiment of the present disclosure, the present disclosure also provides a computer program product, the computer program product, when executed by a processor, is capable of implementing the method for training a reference frame screening model, the method for screening a reference frame as described in any one of the above embodiments.

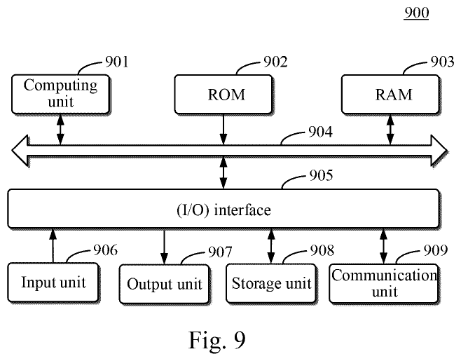

FIG. 9 shows a schematic block diagram of an example electronic device 900 that may be configured to implement embodiments of the present disclosure. The electronic device is intended to represent various forms of digital computers, such as a laptop, a desktop computer, a workbench, a personal digital assistant, a server, a blade server, a mainframe computer, and other suitable computers. The electronic device may also represent various forms of mobile apparatuses, such as a personal digital assistant, a cellular phone, a smart phone, a wearable device, and other similar computing apparatuses. The components shown herein, the connections and relationships thereof, and the functions thereof are used as examples only, and are not intended to limit implementations of the present disclosure described and/or claimed herein.

As shown in FIG. 9, the device 900 includes a computing unit 901, which may execute various appropriate actions and processes in accordance with a computer program stored in a read-only memory (ROM) 902 or a computer program loaded into a random-access memory (RAM) 903 from a storage unit 908. The RAM 903 may further store various programs and data required by operations of the device 900. The computing unit 901, the ROM 902, and the RAM 903 are connected to each other through a bus 904. An input/output (I/O) interface 905 is also connected to the bus 904.

A plurality of components in the device 900 is connected to the I/O interface 905, including: an input unit 906, such as a keyboard and a mouse; an output unit 907, such as various types of displays and speakers; the storage unit 908, such as a magnetic disk and an optical disk; and a communication unit 909, such as a network card, a modem, and a wireless communication transceiver. The communication unit 909 allows the device 900 to exchange information/data with other devices via a computer network such as the Internet and/or various telecommunication networks.

The computing unit 901 may be various general-purpose and/or special-purpose processing components having a processing power and a computing power. Some examples of the computing unit 901 include, but are not limited to, a central processing unit (CPU), a graphics processing unit (GPU), various special-purpose artificial intelligence (AI) computing chips, various computing units running a machine learning model algorithm, a digital signal processor (DSP), and any appropriate processor, controller, micro-controller, or the like. The computing unit 901 executes various methods and processes described above, such as the method for training a reference frame screening model. For example, in some embodiments, the method for training a reference frame screening model may be implemented as a computer software program that is tangibly included in a machine-readable medium, such as the storage unit 908. In some embodiments, some or all of the computer programs may be loaded and/or installed onto the device 900 via the ROM 902 and/or the communication unit 909. When the computer program is loaded into the RAM 903 and executed by the computing unit 901, one or more steps of the method for training a reference frame screening model described above may be executed. Alternatively, in other embodiments, the computing unit 901 may be configured to perform the method for training a reference frame screening model by any other appropriate approach (e.g., by means of firmware).

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a specific-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, specific-purpose computer or other programmable data processing apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more specific example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

A computer system may include a client and a server. The client and the server are generally remote from each other, and generally interact with each other through the communication network. A relationship between the client and the server is generated by computer programs running on a corresponding computer and having a client-server relationship with each other. The server may be a cloud server, also known as a cloud computing server or a cloud host, which is a host product in the cloud computing service system, to solve the defects of management difficulty and weak business scalability in traditional physical host and Virtual Private Server (VPS) service. The server may also be a distributed system server, or a server combined with a blockchain.

According to the technical solutions of embodiments of the present disclosure, a method for training a reference frame screening model, and a method for screening a reference frame are provided, using the machine learning method, using the sequence of video frames in the training samples as the input, using the labels in the training samples representing whether the video frames are reference frames of other video frames in the sequence of video frames as the desired output, training to obtain the reference frame screening model, which improves the accuracy of the reference frame screening model; by screening a set of reference frames corresponding to each video frame in a video sequence using the reference frame screening model, the selection range of reference frames is increased, the fitness between the screened reference frames and the video frame is improved, and the accuracy of motion estimation results is improved.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above specific implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

1. A method for training a reference frame screening model, the method comprising:
acquiring a training sample set, wherein training samples in the training sample set comprise a sequence of video frames and labels corresponding to video frames in the sequence of video frames, and the labels are used to represent whether the video frames corresponding to the labels are reference frames of other video frames in the sequence of video frames; and
training, using a machine learning method, using the sequence of video frames as input, using the labels corresponding to the input sequence of video frames as desired output, to obtain a reference frame screening model.

2. The method according to claim 1, wherein, the training, using a machine learning method, using the sequence of video frames as input, using the labels corresponding to the input sequence of video frames as desired output, to obtain a reference frame screening model, comprises:
training, using the machine learning method, for each video frame in the sequence of video frames, using the video frame as the input, and using a label corresponding to the video frame as the desired output, to obtain the reference frame screening model.

3. The method according to claim 2, wherein, the training, using the machine learning method, for each video frame in the sequence of video frames, using the video frame as the input, and using a label corresponding to the video frame as the desired output, to obtain the reference frame screening model, comprises:
extracting a feature dataset of each video frame in the sequence of video frames, based on a preset feature set, wherein the preset feature set comprises a plurality of feature types indicating the video frames in the sequence of video frames for feature collection; and
training, using the machine learning method, for each video frame in the sequence of video frames, using the feature dataset corresponding to the video frame as the input, and using the label corresponding to the video frame as the desired output, to obtain the reference frame screening model.

4. The method according to claim 3, wherein the method further comprises:
determining importance of each feature data in the feature dataset in a training process; and
the training, using the machine learning method, for each video frame in the sequence of video frames, using the feature dataset corresponding to the video frame as the input, and using the label corresponding to the video frame as the desired output, to obtain the reference frame screening model, comprises:
screening target feature data from the feature dataset based on the importance of the feature data determined in the training process; and
training, using the machine learning method, for each video frame in the sequence of video frames, using a target feature dataset corresponding to the video frame as the input, and using the label corresponding to the video frame as the desired output, to obtain the reference frame screening model.

5. The method according to claim 1, wherein, for each video frame in the sequence of video frames, a label corresponding to the video frame is determined by:
determining, in response to completing a coding operation of the video frame, a number of times each reference frame in a set of reference frames corresponding to the video frame, is referenced in the coding operation of the video frame; and
determining, based on the number of times corresponding to each reference frame is referenced in the set of reference frames, the label corresponding to the video frame.

6. The method according to claim 5, wherein, the determining, in response to completing a coding operation of the video frame, a number of times each reference frame in a set of reference frames corresponding to the video frame, is referenced in the coding operation of the video frame, comprises:
determining, in response to completing the coding operation of the video frame based on a coded block of a preset size, the number of times each reference frame in the set of reference frames corresponding to the video frame, is referenced in the coding operation of the video frame; and
the determining, based on the number of times corresponding to each reference frame is referenced in the set of reference frames, the label corresponding to the video frame, comprises:
determining, for each reference frame in the set of reference frames, based on the number of times being referenced corresponding to the reference frame and a number of the coded blocks in the video frame, a ratio of being referenced of the reference frame in the coding operation of the video frame; and
determining, based on the ratio of being referenced corresponding to each reference frame in the set of reference frames, the label corresponding to the video frame.

7. The method according to claim 1, wherein the method further comprises:
acquiring a target video sequence; and
screening, for each video frame in the target video sequence, using a pre-trained reference frame screening model, target reference frames corresponding to the video frame from a set of candidate reference frames corresponding to the video frame, to obtain a set of target reference frames.

8. The method according to claim 7, wherein, screening, using a pre-trained reference frame screening model, target reference frames corresponding to the video frame from a set of candidate reference frames corresponding to the video frame, to obtain a set of target reference frames, comprises:
in response to determining that a number of target reference frames in the set of target reference frames does not exceed a preset number threshold, cyclically performing determination operations as follows:
extracting a candidate reference frame from the set of candidate reference frames corresponding to the video frame, and extracting target feature data corresponding to the candidate reference frame;
inputting the target feature data into the reference frame screening model to determine whether the candidate reference frame is a target reference frame corresponding to the video frame; and
adding, in response to determining that the candidate reference frame is the target reference frame, the candidate reference frame to the set of target reference frames.

9-19. (canceled)

20. An electronic device, comprising:
at least one processor; and
a memory, communicatively connected to the at least one processor; wherein,
the memory stores instructions executable by the at least one processor, the instructions being executed by the at least one processor to enable the at least one processor to perform operations for training a reference frame screening model, the operations comprising:
acquiring a training sample set, wherein training samples in the training sample set comprise a sequence of video frames and labels corresponding to video frames in the sequence of video frames, and the labels are used to represent whether the video frames corresponding to the labels are reference frames of other video frames in the sequence of video frames; and
training, using a machine learning method, using the sequence of video frames as input, using the labels corresponding to the input sequence of video frames as desired output, to obtain a reference frame screening model.

21. The electronic device according to claim 20, wherein, the training, using a machine learning method, using the sequence of video frames as input, using the labels corresponding to the input sequence of video frames as desired output, to obtain a reference frame screening model, comprises:
training, using the machine learning method, for each video frame in the sequence of video frames, using the video frame as the input, and using a label corresponding to the video frame as the desired output, to obtain the reference frame screening model.

22. The electronic device according to claim 21, wherein, the training, using the machine learning method, for each video frame in the sequence of video frames, using the video frame as the input, and using a label corresponding to the video frame as the desired output, to obtain the reference frame screening model, comprises:
extracting a feature dataset of each video frame in the sequence of video frames, based on a preset feature set, wherein the preset feature set comprises a plurality of feature types indicating the video frames in the sequence of video frames for feature collection; and
training, using the machine learning method, for each video frame in the sequence of video frames, using the feature dataset corresponding to the video frame as the input, and using the label corresponding to the video frame as the desired output, to obtain the reference frame screening model.

23. The electronic device according to claim 22, wherein the operations further comprises:
determining importance of each feature data in the feature dataset in a training process; and
the training, using the machine learning method, for each video frame in the sequence of video frames, using the feature dataset corresponding to the video frame as the input, and using the label corresponding to the video frame as the desired output, to obtain the reference frame screening model, comprises:
screening target feature data from the feature dataset based on the importance of the feature data determined in the training process; and
training, using the machine learning method, for each video frame in the sequence of video frames, using a target feature dataset corresponding to the video frame as the input, and using the label corresponding to the video frame as the desired output, to obtain the reference frame screening model.

24. The electronic device according to claim 20, wherein, for each video frame in the sequence of video frames, a label corresponding to the video frame is determined by:
determining, in response to completing a coding operation of the video frame, a number of times each reference frame in a set of reference frames corresponding to the video frame, is referenced in the coding operation of the video frame; and
determining, based on the number of times corresponding to each reference frame is referenced in the set of reference frames, the label corresponding to the video frame.

25. The electronic device according to claim 24, wherein, the determining, in response to completing a coding operation of the video frame, a number of times each reference frame in a set of reference frames corresponding to the video frame, is referenced in the coding operation of the video frame, comprises:
determining, in response to completing the coding operation of the video frame based on a coded block of a preset size, the number of times each reference frame in the set of reference frames corresponding to the video frame, is referenced in the coding operation of the video frame; and
the determining, based on the number of times corresponding to each reference frame is referenced in the set of reference frames, the label corresponding to the video frame, comprises:
determining, for each reference frame in the set of reference frames, based on the number of times being referenced corresponding to the reference frame and a number of the coded blocks in the video frame, a ratio of being referenced of the reference frame in the coding operation of the video frame; and
determining, based on the ratio of being referenced corresponding to each reference frame in the set of reference frames, the label corresponding to the video frame.

26. The electronic device according to claim 20, wherein the operations further comprises:
acquiring a target video sequence; and
screening, for each video frame in the target video sequence, using a pre-trained reference frame screening model, target reference frames corresponding to the video frame from a set of candidate reference frames corresponding to the video frame, to obtain a set of target reference frames.

27. The electronic device according to claim 26, wherein, screening, using a pre-trained reference frame screening model, target reference frames corresponding to the video frame from a set of candidate reference frames corresponding to the video frame, to obtain a set of target reference frames, comprises:
in response to determining that a number of target reference frames in the set of target reference frames does not exceed a preset number threshold, cyclically performing determination operations as follows:
extracting a candidate reference frame from the set of candidate reference frames corresponding to the video frame, and extracting target feature data corresponding to the candidate reference frame;
inputting the target feature data into the reference frame screening model to determine whether the candidate reference frame is a target reference frame corresponding to the video frame; and
adding, in response to determining that the candidate reference frame is the target reference frame, the candidate reference frame to the set of target reference frames.

28. A non-transitory computer readable storage medium storing a computer instruction, wherein, the computer instruction is used to cause a computer to perform operations for training a reference frame screening model, the operations comprising:
acquiring a training sample set, wherein training samples in the training sample set comprise a sequence of video frames and labels corresponding to video frames in the sequence of video frames, and the labels are used to represent whether the video frames corresponding to the labels are reference frames of other video frames in the sequence of video frames; and
training, using a machine learning method, using the sequence of video frames as input, using the labels corresponding to the input sequence of video frames as desired output, to obtain a reference frame screening model.

29. The storage medium according to claim 28, wherein, the training, using a machine learning method, using the sequence of video frames as input, using the labels corresponding to the input sequence of video frames as desired output, to obtain a reference frame screening model, comprises:
training, using the machine learning method, for each video frame in the sequence of video frames, using the video frame as the input, and using a label corresponding to the video frame as the desired output, to obtain the reference frame screening model.

30. The storage medium according to claim 29, wherein, the training, using the machine learning method, for each video frame in the sequence of video frames, using the video frame as the input, and using a label corresponding to the video frame as the desired output, to obtain the reference frame screening model, comprises:
extracting a feature dataset of each video frame in the sequence of video frames, based on a preset feature set, wherein the preset feature set comprises a plurality of feature types indicating the video frames in the sequence of video frames for feature collection; and
training, using the machine learning method, for each video frame in the sequence of video frames, using the feature dataset corresponding to the video frame as the input, and using the label corresponding to the video frame as the desired output, to obtain the reference frame screening model.

31. The storage medium according to claim 30, wherein the operations further comprises:
determining importance of each feature data in the feature dataset in a training process; and
the training, using the machine learning method, for each video frame in the sequence of video frames, using the feature dataset corresponding to the video frame as the input, and using the label corresponding to the video frame as the desired output, to obtain the reference frame screening model, comprises:
screening target feature data from the feature dataset based on the importance of the feature data determined in the training process; and
training, using the machine learning method, for each video frame in the sequence of video frames, using a target feature dataset corresponding to the video frame as the input, and using the label corresponding to the video frame as the desired output, to obtain the reference frame screening model.
